(19) United States
(12) Patent Application Publication
(10) Pub. No.: US 2003/0051620 A1
(43) Pub. Date: Mar. 20, 2003

(54) Method and device for supplying hydraulic fluid

(76) Inventor: Karl Robert Schafer, Rimpar (DE)

Correspondence Address: Douglas R Hanscom, Jones Tullar & Cooper, P O Box 2266 Eads Station, Arlington, VA, 22202, US

(21) Appl. No.: 10/239,191

(22) PCT Filed: Feb. 1, 2001
(86) PCT No.: PCT/DE01/00384

(30) Foreign Application Priority Data
Mar. 27, 2000 (DE) 100 15 165.5

(51) Int. Cl. B41F 27/12

(52) U.S. Cl. 101/415.1

(57) ABSTRACT

The invention relates to reversible, deformable hollow bodies for actuating retaining and/or clamping devices, which are inserted into cylinders, in particular into cylinders of printing presses. Said hollow bodies require a sealed supply channel for the hydraulic fluid that is easy to mount. To achieve a self-sealing supply channel of a hydraulic fluid to the hollow body (01), which can be simply and quickly mounted, the sealing surfaces and dividing surfaces between the cylinder (02) and the hollow body that can be separated. are arranged approximately parallel to one another and almost perpendicular to the direction of the pressure (P) which is generated when impinged by hydraulic fluid. In one advantageous embodiment, the dividing surfaces or the sealing surfaces do not penetrate one another.

The invention relates to a method and a device for supplying a pressure medium in accordance with the preamble of claims 1 and 3 or 6.

An arrangement of a hose used for operating a device for clamping flexible printing plates on a forme cylinder and which can be charged with a pressure medium is known from EP 0 606 604 B1. The hose is arranged on a fastening strip, fixed in place on the cylinder, in the axial extension approximately in the middle between two axial, prestressed clamping strips extending in an axis-parallel groove.

The supply of pressure medium to the hose is performed via a connecting tube. The connecting tube extends through the fastening strip and is frictionally connected with a muff on the underside of the fastening strip facing away from the hose. The muff is sealed with the aid of sealing rings and is connected with a flange arranged on the underside of the fastening strip. The sealing faces between the connecting tube and the muff, or between the muff and the flange, extend parallel in respect to the pressure and force direction.

The connecting tube, embodied as a threaded pin with a bore in the example, projects on the side facing the hose through a hole in the casing of the hose into its interior. The connecting tube can be fastened releasably and interlockingly in the interior of the hose by means of a nut.

When mounting the hose, the hole in the hose casing must be pushed on the connecting tube fixed on the cylinder and, if required, must be fastened on the inside of the hose with a nut. In the present example the mounting of the hose must be performed in the radial direction from the shell surface of the cylinder.

When a pressure medium is supplied to the hose through the connecting tube, the hose pushes the two clamping strips apart in the circumferential direction.

EP 0 307 890 B1 shows a device for clamping and bracing printing plates on a plate cylinder, using hoses which can be charged with a pressure medium. For bracing the printing plate, the entire bracing and clamping device, which is movably arranged in the cylinder groove, is displaced approximately in the circumferential direction. This takes place against the force of a restoring spring by means of a hose, which can be charged with a pressure medium and is supported on the groove wall fixed in the cylinder. The clamping device is operated by means of a toggle lever, which is maintained in the clamping position by a spring force. A hose is used for opening which, when charged with a pressure medium, forces the toggle lever out of the stretched position against the spring force. The introduction of a pressure medium into the hose is not explained.

DE 33 09 815 C2 discloses a clamping device for a cylinder shell, wherein a clamping sleeve, together with the shell surface of a journal and O-rings arranged between the journal and the clamping sleeve, form a deformable annular chamber. The supply of a pressure medium takes place, inter alia, through a radial bore through the journal, with an orifice in the annular chamber. When charged with a pressure medium, the clamping sleeve is deformed in the radial direction of the journal and holds a front disk of a cylinder shell.

Further examples of mechanisms of devices for holding or clamping of dressings on cylinders to be operated by means of pressure media are provided in the publications EP 0 606 604 B1, EP 0638 420 A1, EP 0 713 770 B1, EP 0 740 609 B1 or EP 0 858 890 A1, and represent a lever mechanism, the drive mechanism for a toothed rack or leaf spring, a displaceable clamping jaw or the dressing itself, which is to be held. The mentioned examples require an assembly at the front, or laterally inside the channel, of the hose which can be charged with pressure medium in the cylinder.

A solution for supplying a medium charged with pressure to a rotatable body itself is proposed in the publication EP 0 554 815 A1, for example.

The object of the invention is based on providing a method and a device for supplying a pressure medium.

In accordance with the invention, this object is attained by means of the characteristics of claims 1 and 3, or 6.

The advantages to be realized by means of the invention reside in particular in that only slight demands are to be made on the accessibility of the supply device for the pressure medium and the position of the hose, since there is no rigid passage, fixed in the cylinder, through the hose wall. The device designed in accordance with the invention permits the arrangement and exchange of hoses to be supplied with pressure media at places inside the cylinder, or the clamping device, which are difficult to reach. The supply device permits various types of employment of hoses to be charged with pressure medium for operating holding or clamping devices. For example, the pressure medium hose can be inserted inside the channel into the clamping device in the circumferential direction laterally or at the front.

It is also an advantage of the device of the invention that in case of a relative movement between the hose of the line for supplying the pressure medium no damages occur, because the parts of the supply line to be assigned to the cylinder and to the hose do not penetrate each other.

A further advantage of the device of the invention for supplying pressure medium is the simple and rapid pre-assembly, as well as the insertion into the clamping device, without a requirement for a tool or aids.

The self-sealing property of the device of the invention because of the arrangement of the sealing faces perpendicularly to the pressure and force direction acting in the operating state is particularly advantageous.

An exemplary embodiment of the invention is represented in the drawings and will be described in greater detail in what follows.

Shown are in:

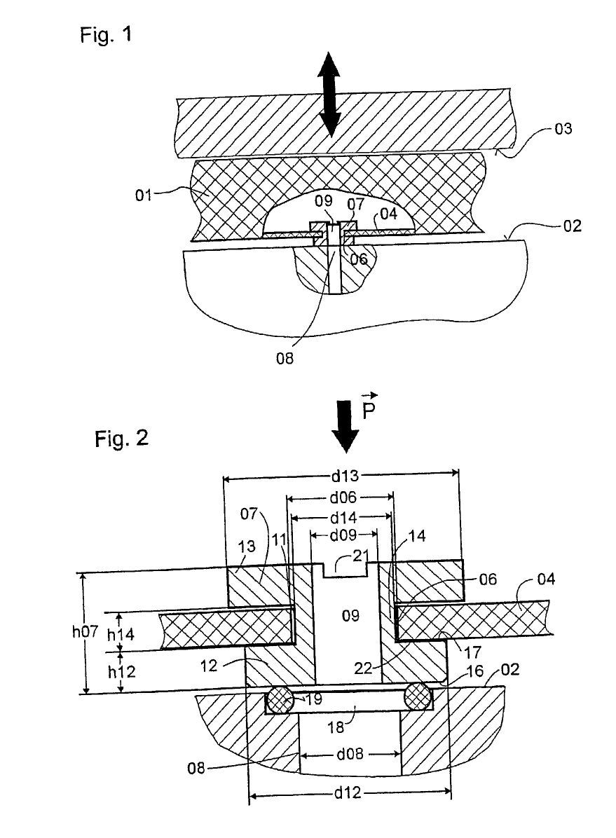

FIG. 1, a schematic representation of a hose, which can be charged with a pressure medium, and a supply device,

FIG. 2, an enlarged representation of the passage in FIG. 1.

A device, not described in detail, for the frictional or interconnected holding and/or clamping of at least one dressing, for example a printing plate on a forme cylinder, or a rubber blanket on a transfer cylinder, is arranged in a cylindrical body, for example a forme or transfer cylinder of a printing press, in an axially extending channel of a cylinder shell.

The actuation of the device for clamping or holding of the dressing takes place via a deformable hollow body, for example a hose 01, which is present in the channel of the cylinder and which can be charged with a fluid as the pressure medium, for example compressed air.

The hose 01 is arranged between a surface 02, for example the support surface 02, assigned to the cylinder, and a surface 03, which is assigned to the device for clamping or holding to be operated. For example, the support surface is embodied as a lateral wall of the channel, fixed in the cylinder, but in another embodiment it can also be a surface of the movable device for holding or clamping.

On its side facing the support surface 02, the hose 01 has an opening 09, through which the pressure medium is fed into the hose 01. The opening 09 cooperates with a mouth of a line 06, which is arranged in the side of the support surface 02 facing the hose 01.

The opening 09 can be a cutout 06 in the wall 04. However, it can also be a bore 09 in a passage 07 arranged in the cutout 06 of the wall 04.

In the present example the opening 09 in the hose 01 is embodied as an axial bore of a disk 07 arranged in the cutout 06 of the hose 01. The disk 07 is provided with a circumferential groove 11 in its shell surface. The groove 11 divides the disk 07 into a flange 12 facing the support surface 02, a flange 13 located in the interior of the hose 01, and a constriction 14 located between them. On the front of the outer flange 12 there is a surface 16 which, together with the support surface 02, acts as a sealing face, and on its side facing the hose 01 a surface 17, also acting together as a sealing face with the wall 04 of the hose 01.

In an advantageous embodiment of the disk 07, the structure of the surface 16 should not exceed a surface roughness of 16 μm, preferably 4 μm. The surface 17 does not make such high demands on the surface structure, so that a surface roughness of 16 μm is sufficient.

The interior diameter d09 of the bore 09 of the disk 07 depends on the required pressure medium flow and in the present example d09=3 mm. The exterior diameter d14 of the constriction 14, for example, is d14=6 mm. The exterior diameter d12, for example d12=8.5 mm, of the flange 12 is a result of the demands made on the seal of the surface 16 of the disk 07 toward the support surface 02, and the surface 17 of the disk 07 toward the wall 04 of the hose 01. The flange 13 is used for holding the disk 07 in the wall 04 of the hose 01, and in the example has an exterior diameter of d13=10 mm. The disk 07 has a height h of, for example, h07=3.5 mm. In the example, the flange 12 is embodied with a height h12=1 mm, and the constriction with a height h14=1.5 mm, which depends on the thickness of the wall 04 of the hose 01. In a preferred embodiment the disk 07 has a radially extending groove 21 on the front face 13. This groove 21 makes possible the supply, or the escape, of the pressure medium in case the wall 04 of the hose 01, which is located directly opposite the flange 13, rests directly on the flange 13.

In place of the disk 07 described in the example, other constricted forms of embodiment can be selected as the passage 07, which have a disk (embodied as flange 12 in the example) cooperating with the support surface 02, with a flat surface 16, a flat surface 17 cooperating with the wall 04, if required, a detent (embodied as flange 13 in the example) arranged in the interior of the hose 01, a taper (embodied as constriction 14 in the example), which projects at least partially into the wall 04, and a penetrating opening extending in the longitudinal direction (in the example a bore 09). The taper 14 can also be embodied as a tube which, when there is a detent 13, connects the latter with the disk 12.

On the side of the hose 01 facing the support surface 02, the cutout 06 is located in the wall 04, in which the disk 07 is rranged. Advantageously the diameter d06 of the cutout 06 (for example d06=5 mm) has been selected, depending on the elastic properties of the hose material, to be less than the exterior diameter d14 of the constriction 14, so that an interconnected and frictional tight connection between the disk 07 and the hose 01 is created. Several disks 07 and associated mouths of lines 08 per hose 01 can be provided in the support surface 02. For reasons of assembly, the disk 07 and the associated mouth of the line 08 are preferably arranged in the area of the ends of the hose 01. The disk 07 is positioned on the hose 01 in such a way that, with the hose 01 inserted into the channel of the cylinder, the longitudinal axis of the bore 09 and the longitudinal axis of the mouth of the line 08 cooperating with the disk 07 are flush in the ideal case, or that the bore 09 and the mouth of the line 08 at least intersect.

The hose 01, equipped with a disk 07, is arranged in the channel, fixed in relation to the support surface 02, in such a way that the surface 16 facing the support surface 02 rests on the support surface 02, even in the relaxed state of the hose 01 when not charged with a pressure medium.

The interior diameter d08 of the mouth of the line 08 can be equal to the interior diameter d09 of the opening 09, or bore 09. For the purpose of an assured intersection of the mouth of the line 08 and the opening 09, the interior diameter of mouth of the line d08 (for example d08=5 mm) can be selected to be greater than d09. This embodiment assures the certain coverage of the mouth of the line 08 by the flange 13, even in the flaccid state where the hose 01 is not charged with a pressure medium, as well as in case of manufacturing or assembly tolerances in the arrangement of the hose 01, or of the disk 07, or of the mouth of the line 08.

A further increase of the interior diameter d08 also requires an increase of the cooperating flange 12. When using a passage 07, the exterior diameter d12 of the outside located flange, the interior diameter d09 of the bore 09 and the interior diameter d08 of the mouth of the line 08 should be selected in an advantageous manner in such a way, that

$$\frac{( d12 - d09 )}{2} < d08 < \frac{( d12 + d09 )}{2}$$

is met.

In a further embodiment of the invention, not represented, the interior diameter of the bore 09 of the disk 07 can also be selected to be larger than the interior diameter d08 of the mouth of the line 08.

In an advantageous manner, similar demands should be made on the surface structure of the support surface 2, at least in the area of the mouth of the line 08, than are made on the surface 16, namely a surface roughness of less than or equal to 16 μm. Alternatively to this it is possible to arrange a sealing element 19, such as for example a rubber or metal seal ring, in a groove 18 surrounding the mouth of the line 08 in the support surface 02. The sealing element 19 arranged in the support surface 02, and the surface 16 of the disk 07 facing it, in this case act together as sealing faces.

If, in an embodiment variation of the device of the invention, the use of a disk 07, or a passage 07 of a different type, is omitted, the cutout 06 of the hose 01 constitutes the opening 09 for supplying the pressure medium to the hose 01. In this case the support surface 02, or the sealing element 19 arranged in it, and the surface 22 of the wall 04 facing the support surface 02, act together as a sealing face.

When charged with a pressure medium, the same pressure acts inside the hollow body 01 on all surfaces in the normal direction. Here, the direction of the pressure P is understood to be the direction which is oriented approximately parallel with the longitudinal axis of the opening 09. The embodiments mentioned have in common the arrangement of sealing faces, which are almost perpendicular in respect to the direction of the pressure P, between the two units, which are designed so they can be separated from each other, and therefore the self-sealing property of the device for supplying the pressure medium. When charged with pressure, the sealing faces are pressed against each other, so that in the operational state the charging of the hose 01 with pressure medium itself supplies the seal of the supply device.

The support surface 02 to be assigned to the cylinder with the mouth of the line 08 constitutes a first unit, and the hollow body 01 with the opening 09 and with the surface 16, or 22, a second unit acting together with the first unit, which are designed to be separable from each other. The seal of the supply device for pressure medium between these two units, which can be separated from each other, takes place via the surfaces 16 or 22, together with the support surface 02, or the sealing element 19.

The separating and sealing faces are located on planes which, when the hollow body 01 is charged with pressure medium, extend almost perpendicularly in respect to the direction of the pressure P. Since the two units do not penetrate each other, in the state when pressure is applied, the connection takes place only in a frictionally connected manner in all spatial directions. The hollow body 01 with the opening 09, if required with the passage 07 having the opening 07, can in this way be inserted, or removed, in a simple manner, and can be separated from the support surface 02 to be assigned to the cylinder. A separation takes place in an advantageous manner almost perpendicularly in respect to the mouth of the line 08, or of the opening 09.

The mounting and mode of functioning of the device are as described in what follows:

A cutout 06 is arranged in the hose 01 at the location in the hose 01 defined by the position of the mouth of the line 08 and the hose 01. The disk 07 having the opening 09 is pushed, for example from the inside of the hose 01, through the cutout 06. The device for supplying the pressure medium, consisting of the hose 01 and the disk 07, is inserted into an appropriate holder, not described in greater detail here, in the channel of the cylinder. After the device for supplying has been inserted with the correct fit in respect to the position of the mouth of the line 08, i.e. so that the mouth of the line 08 and the opening 09 at least partially intersect, the supply device is ready to operate. Thereafter, and as explained in greater detail below, the charging of the hollow body 01 with pressure medium takes place, and with this the simultaneous sealing between the surfaces 02, 16, or 22, which are arranged to lie flat on each other and do not penetrate each other, namely the support face 02 and the surface 16, or 22, of the passage 07, or of the hollow body 01.

Upon actuating a device, not represented here, for providing pressure medium, pressure medium, for example compressed air, flows through the mouth of the line 08 and the bore 09 of the disk 07 into the hose 01. The previously flaccid hose 01 is filled and takes up more space. It is supported on the support surface 02 and actuates via the surface 03 the device for clamping or releasing, holding or letting go, of dressings on cylinders. Because of the resistance of the clamping or holding device which can result from the dressing to be clamped itself, from a spatial limitation, or from the restoring force of the device, the wall 04 of the hose 01, and therefore also the flange 12, are pressed against the support surface 02, and the surface 16 is frictionally and self-sealingly connected with the support surface 02. In the same way the surface 22 of the hose 01 is self-sealingly connected with the surface 17.

In connection with an embodiment of the supplying device, but with the use of a passage 07, the surface 22 of the wall 04 is directly connected with the support surface 02 in a self-cleaning and frictionally connected manner.

### List of Reference Numerals

01 Hose, hollow body

02 Surface, support surface

03 Surface

04 Wall

05 -

06 Cutout

07 Disk, passage

08 Mouth of the line

09 Bore, opening

10 -

11 Groove

12 Flange, disk

13 Flange, detent

14 Constriction, taper

15 -

16 Surface

17 Surface

18 Groove

19 Sealing element

20 -

21 Groove

22 Surface

Direction, pressure

Diameter (06)

Diameter (08)

d09 Interior diameter (09)

d12 Exterior diameter (12)

d13 Exterior diameter (13)

d14 Exterior diameter (14)

h07 Height (07)

h12 Height (12)

h14 Height (14)

1. A method for supplying pressure medium to a reversibly deformable hollow body, wherein the hollow body (01), which is provided with an opening (09) in a surface (16, 22) of its wall (04), is arranged on a support surface (02) having a mouth of a line (08), wherein the mouth of the line (08) and the opening (09) are arranged so that they intersect at least partially, and afterwards the charging of the hollow body (01) with the pressure medium and a simultaneous sealing between the faces of the support surface (02) and the hollow body (01), which lie flat on each other and do not penetrate each other, takes place.

2. The method in accordance with claim 1, characterized in that the hollow body (01) is provided with a passage (07) having the opening (09) in a cutout (06) in its wall (04), and that the seal takes place between the surface (16) assigned to the passage (07) and the support surface (02).

3. A device for supplying pressure medium to a reversibly deformable hollow body, wherein the hollow body (01), which is provided with an opening (09) in a surface (16, 22) of its wall (04) for supplying the pressure medium, is arranged on a support surface (02) having a mouth of a line (08), wherein the mouth of the line (08) and the opening (09) are arranged so that they intersect at least partially, characterized in that the surface (16, 22) of the hollow body (01) and the support surface (02), which together act as sealing faces, are arranged so that they can be separated from each other, are nearly parallel in respect to each other and in a plane almost perpendicular to the direction of the pressure (P) being generated in the course of charging with pressure medium.

4. The device in accordance with claim 3, characterized in that the surface (22), which acts together with the support surface (02), is a part of the wall (04) of the hollow body (01), and that the opening (09) is embodied as a cutout (06) in the wall (04) of the hollow body (01).

5. The device in accordance with claim 3, characterized in that the surface (16), which acts together with the support surface (02), is a part of a passage (07) arranged in a cutout (06) of the wall (04) of the hollow body (01) and has a surface (17), which acts together with the outward pointing surface (22) of the hollow body (01) and extends almost parallel with the surface (22), and a flat surface (16), which points away from the hollow body (01).

6. A device for supplying pressure medium to a reversibly deformable hollow body (01), wherein the hollow body (01) has a cutout (06) in the area of an outward oriented surface (16) of its wall (04), in which a passage (07) for supplying the pressure medium to the hollow body (01) is interlockingly arranged, characterized in that the passage (07) has a surface (17), which acts together with the outward pointing surface (22) of the hollow body (01) and extends almost parallel with the surface (22), and a flat surface (16), which points away from the hollow body (01).

7. The device in accordance with claim 6, characterized in that the passage (07) has an opening (09) penetrating it in the longitudinal direction.

8. The device in accordance with claim 6, characterized in that a support surface (02), which has a mouth of a line (08), is arranged opposite the surface (16) of the passage (07).

9. The device in accordance with claim 8, characterized in that the hollow body (01) and the support surface (02) are arranged so they can be separated from each other, and that the surface 16 of the passage (07) and the support surface (02), which act together as sealing faces, are arranged so they can be separated from each other, extend almost parallel with each other, and lie in a plane almost perpendicular to the direction of the pressure (P) generated when there is a charge with a pressure medium.

10. The device in accordance with claim 7 and 8, characterized in that the opening (09) and the mouth of the line (08) are arranged so they intersect at least partially.

11. The device in accordance with claim 3 or 10, characterized in that the opening (09) and the mouth of the line (08) are arranged so they do not penetrate each other.

12. The device in accordance with claim 3 or 10, characterized in that when the hollow body (01) is charged with a pressure medium, the surface (16, 22) assigned to the opening (09) is connected with the support surface (02) in a frictionally connected and self-sealing manner.

13. The device in accordance with claim 5 or 6, characterized in that the surface (16) of the passage (07) which points away from the hollow body (01) extends almost perpendicularly to the direction of the pressure (P) created in the course of a charge with pressure medium.

14. The device in accordance with claim 5 or 6, characterized in that the surface (22) of the wall (04) and the surface (17) of the passage (07) facing the wall (04) are arranged so they act together as sealing faces almost perpendicularly to the direction of the pressure (P) when being charged with a pressure medium.

15. The device in accordance with claim 5 or 6, characterized in that the passage (07) has a disk (12) and a taper (14) projecting at least partially into the wall (04) of the hollow body (01).

16. The device in accordance with claim 15, characterized in that the surface (16) pointing away from the hollow body, and the surface (17) acting together with the wall (04) of the hollow body (01) are parts of the disk (12).

17. The device in accordance with claim 9 and 15, characterized in that an exterior diameter (d12) of the disk (12), an interior diameter (d09) of the opening (09) and an interior diameter (d08) of the mouth of the line (08) are selected in such a way that
$$\frac{( d12 - d09 )}{2} < d08 < \frac{( d12 + d09 )}{2}$$
applies.

18. The device in accordance with claim 15, characterized in that a detent (13) is arranged on a face of the taper (14) opposite the disk (12).

19. The device in accordance with claim 18, characterized in that the detent (13) has a groove (21) on the front face pointing into the interior of the hollow body (01).

20. The device in accordance with claim 3 or 8, characterized in that a sealing element is arranged in the support surface (02) and/or the surface (16, 22).

21. The device in accordance with claim 3 or 6, characterized in that the hollow body (01) is arranged in a device for holding and/or clamping of at least one thin dressing on a cylinder of a printing press for the purpose of operating this device.

22. The device in accordance with claim 3 or 6, characterized in that the hollow body (01) is arranged in a device for holding and/or clamping of at least one printing plate on a formed cylinder of a printing press for the purpose of operating this device.
